(19) United States
(12) Patent Application Publication
(10) Pub. No.: US 2016/0055271 A1
(43) Pub. Date: Feb. 25, 2016

(54) DATA STRUCTURE OF DESIGN DATA OF SEMICONDUCTOR INTEGRATED CIRCUIT AND APPARATUS AND METHOD OF DESIGNING SEMICONDUCTOR INTEGRATED CIRCUIT

(71) Applicant: RENESAS ELECTRONICS CORPORATION, Tokyo (JP)

(72) Inventor: Fumitaka FUKUZAWA, Tokyo (JP)

(21) Appl. No.: 14/830,652

(22) Filed: Aug. 19, 2015

(30) Foreign Application Priority Data
Aug. 22, 2014 (JP) 2014-169676

(51) Int. Cl. G06F 17/50

(52) U.S. Cl. CPC G06F 17/505

(57) ABSTRACT

The present invention is directed to easily change design of RTL circuit data according to design specifications such as power consumption and operation frequency. RTL circuit data of a semiconductor integrated circuit includes a first description expressing a specific module or specific circuit element and a second description with which at least a part of the first description is replaced, thereby adding a new function to a specific module or circuit element. When a computer performs logic synthesis on the RTL circuit data, either logic synthesis is performed on the first description as it is, or a part of the first description is replaced with the second description and the logic synthesis is performed on the resultant is determined on the basis of selection information.

### CROSS-REFERENCE TO RELATED APPLICATIONS

The disclosure of Japanese Patent Application No. 2014-169676 filed on Aug. 22, 2014 including the specification, drawings and abstract is incorporated herein by reference in its entirety.

### BACKGROUND

The present invention relates to a data structure of design data of a semiconductor integrated circuit and an apparatus and method of designing a semiconductor integrated circuit and, for example, is preferably used for circuit designing using a soft macro provided as circuit data of a register transfer level.

In designing of LSI (Large Scale Integration) in recent years, development using a hardware description language is being generally performed. In this case, to improve development efficiency, an IP (Intellectual Property) core obtained by collecting circuit information on a function block unit basis is often provided from a vendor. A developer performs circuit designing by using the provided IP core.

An IP core incudes a hard macro provided as layout data for manufacturing a mask and a soft macro as circuit data at a register transfer level (RTL) described in a hardware description language (HDL). Since a hard macro depends on a semiconductor manufacturing process, it is difficult to customize it. However, a soft macro can be customized to the certain degree.

Various other methods for increasing efficiency of LSI design are also proposed. For example, Japanese Unexamined Patent Application Publication (Translation of PCT Application) No. 2003-518280 (patent literature 1) discloses a system for expediting development of a microprocessor by automatizing generation of HDL description data of a hardware and a software development tool.

### RELATED ART LITERATURE

### Patent Literature

Patent literature 1: Japanese Unexamined Patent Application Publication (Translation of PCT Application) No. 2003-518280

### SUMMARY

In practice, it is often difficult to customize a soft macro supplied from a vendor in accordance with design specifications on the user side. Since the user does not know the details of a soft macro, there is a risk of an operation failure caused by modifying the soft macro. Further, to customize a soft macro so as to match design specifications such as operation frequency and power consumption, correction of circuit data and evaluation by simulation have to be repeatedly performed, so that it is not realistic from the viewpoint of cost and development time.

The other subject and novel feature will become apparent from the description of the specification and the appended drawings. RTL circuit data of a semiconductor integrated circuit according to an embodiment includes a first description expressing a specific module or specific circuit element and a second description with which at least a part of the first description is replaced, thereby adding a new function to a specific module or circuit element. When a computer performs logic synthesis on the RTL circuit data, either logic synthesis is performed on the first description as it is, or a part of the first description is replaced with the second description and the logic synthesis is performed on the resultant is determined on the basis of selection information.

According to the embodiment, design change of RTL circuit data can be easily performed according to design specifications such as power consumption and operation frequency.

### BRIEF DESCRIPTION OF THE DRAWINGS

FIG. 1 is a diagram schematically illustrating a general configuration of an apparatus for designing a semiconductor integrated circuit.

FIG. 2 is a flowchart illustrating a procedure of designing a semiconductor integrated circuit.

FIG. 3 is a diagram illustrating data structure of design data in FIG. 1.

FIG. 4 is a circuit diagram in the case of performing clock gating to a flip flop.

FIG. 5 is a circuit diagram of a free-running flip flop to which clock gating is not performed.

FIG. 6 is a diagram illustrating an example of HDL descriptions which can be selected by the circuit of FIG. 4 and the circuit of FIG. 5.

FIG. 7 is a circuit diagram illustrating an example of the case of performing operand isolation on input data of an arithmetic unit.

FIG. 8 is a circuit diagram illustrating an example of the case where operand isolation is not performed on input data of the arithmetic unit.

FIG. 9 is a diagram illustrating an example of HDL descriptions which can be selected by a circuit 25A in FIG. 7 and a circuit 25B in FIG. 8.

FIG. 10 is a circuit diagram illustrating an example of the case of performing gating of an address and data input to a memory.

FIG. 11 is a circuit diagram illustrating an example of the case where gating of an address and data input to a memory is not performed.

FIG. 12 is a diagram illustrating an example of HDL descriptions which can be selected by a circuit 37A in FIG. 10 and a circuit 37B in FIG. 11.

FIG. 13 is a circuit diagram illustrating an example of the case of providing a bypass path of arithmetic data in a data path of a CPU.

FIG. 14 is a circuit diagram illustrating an example of the case where a bypass path of arithmetic data is not provided in the data path of the CPU.

FIG. 15 is a diagram illustrating an example of HDL descriptions which can be selected by an arithmetic stage 50A in FIG. 13 and an arithmetic stage 50B in FIG. 14.

FIG. 16 is a diagram illustrating an example of an HDL description of a top module (fine name: top.v).

FIG. 17 is a diagram illustrating an HDL description example of a module A assembled in the top module of FIG. 16.

FIG. 18 is a diagram illustrating an HDL description example of a module B assembled in the top module of FIG. 16.

FIG. 19 is a diagram illustrating an HDL description example of a module C assembled in the top module of FIG. 16.

FIG. 20 is a diagram illustrating a description example of macro definition.

FIG. 21 is a diagram for illustrating selection information used in design data of a semiconductor integrated circuit according to a third embodiment.

FIG. 22 is a diagram illustrating the relation between power consumption and operation frequency on each of selection patterns of FIG. 21.

FIG. 23 is a flowchart illustrating a method of generating design data of a semiconductor integrated circuit.

FIG. 24 is a flowchart for more specifically explaining the procedure of step S115 in FIG. 23.

FIG. 25 is a diagram illustrating an HDL description example of the module A in the case of the fourth embodiment.

FIG. 26 is a diagram illustrating a description example of macro definition in the case of the fourth embodiment.

FIG. 27 is a diagram illustrating, in a table form, the relation between the name of a macro defined in FIG. 26 and power consumption and maximum operation frequency (high-speed operation) of the circuit.

### DETAILED DESCRIPTION

Hereinbelow, each of embodiments will be described specifically with reference to the drawings. The same reference numeral is designated to the same or corresponding parts and its description will not be repeated.

### First Embodiment

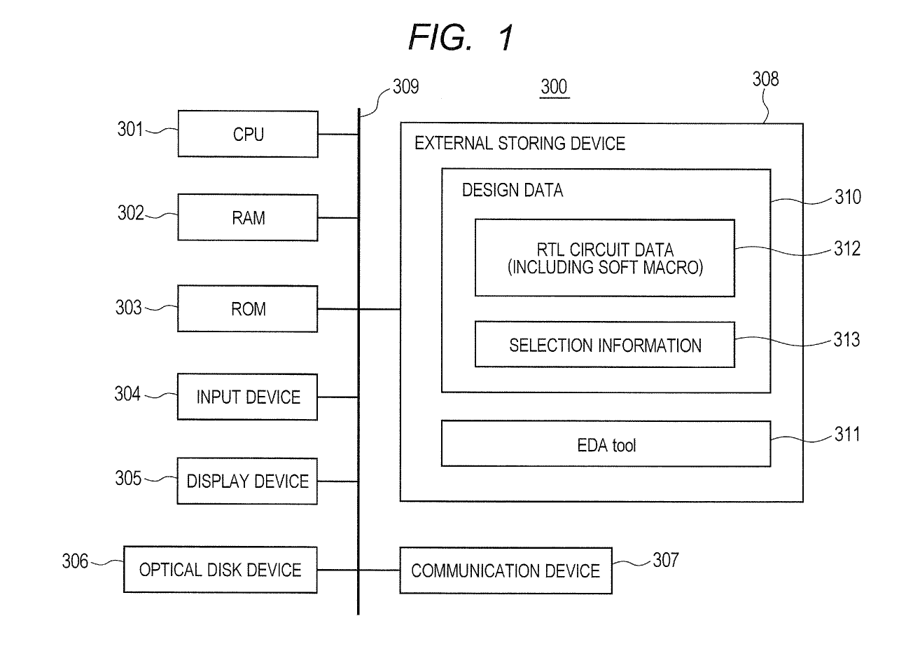

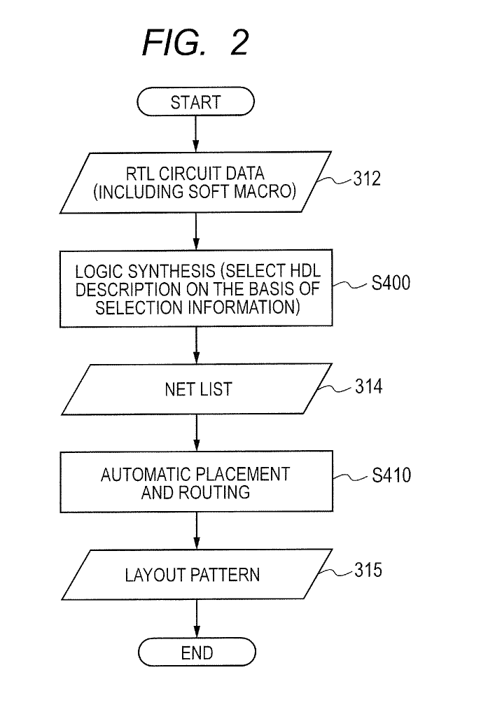

FIG. 1 is a diagram schematically illustrating a general configuration of an apparatus for designing a semiconductor integrated circuit. FIG. 2 is a flowchart illustrating a procedure of designing a semiconductor integrated circuit.

Referring to FIG. 1, a design apparatus 300 is configured using a computer as a base and includes a CPU (Central Processing Unit) 301, a RAM (Random Access Memory) 302, a ROM (Read Only Memory 303, an input device 304, a display device 305, an external storing device 308, an optical disk device 306, and a communication device 307.

In the external storing device 308 such as a hard disk, design data 310 of a semiconductor integrated circuit and an EDA tool (logic synthesis tool, simulation tool, Place and Route(P&R) tool, and the like) 311 are stored. The design data 310 includes RTL circuit data 312 described in the HDL. The RTL circuit data 312 is comprised of a soft macro provided from a vendor or the like. The soft macro is obtained via a non-temporary storage medium such as a DVD or CD-ROM or via a network coupled to the communication device 307 and taken by a computer.

The CPU 301 functions as a data processing device processing the design data 310. The RAM 302 and the ROM 303 are used as amain storage when the CPU 301 operates. Concretely, the CPU 301 generates a net list 314 by performing logic synthesis of the RTL circuit data 312 in accordance with an instruction input from the user (step S400 in FIG. 2). The CPU 301 further generates a layout pattern 315 by performing placement and routing on the basis of the net list 314 (step S400 in FIG. 2). The user can interactively proceed designing of the semiconductor integrated circuit by using the input device 304 such as a keyboard and a mouse and the display device 305 such as a liquid crystal display device.

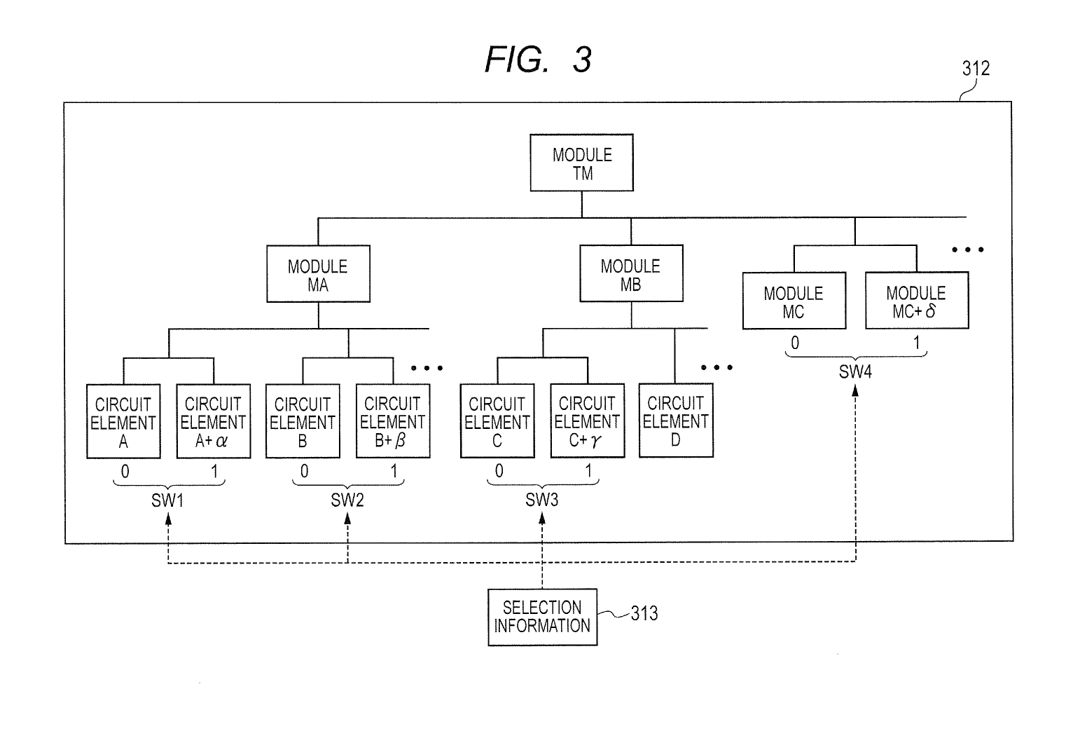

FIG. 3 is a diagram illustrating the data structure of the design data in FIG. 1. Referring to FIG. 3, the RTL circuit data 312 is data of a semiconductor integrated circuit described at a register transfer level (RTL) by using the hardware description language (HDL) and has a structure in which a plurality of modules MA, MB, MC, and TM are hierarchized. The function of each of the modules is expressed by the HDL at the register transfer level (RTL). At the RTL, the location of a register (order element) holding data is clearly defined, and the flow of data among the registers is described. That is, combination circuits existing among the registers are described.

In the specification, a circuit block such as an arithmetic circuit, a control circuit, and a memory circuit configuring a semiconductor integrated circuit will be called a module. Each of the modules is comprised of a plurality of circuit elements such as a register (flip flop), a multiplexer, a comparator, and a state machine.

Concretely, in the case of FIG. 3, the RTL circuit data 312 includes the top module TM and a plurality of modules MA, MB, MC, . . . called from the top module TM. The module MA includes HDL descriptions expressing a plurality of circuit elements A, B, . . . Similarly, the module MB includes HDL descriptions expressing a plurality of circuit elements C, D, . . . .

Further, the RTL circuit data 312 includes an HDL description adding a new function α to the circuit element A by replacing at least a part of the HDL description expressing the circuit element A. Similarly, the RTL circuit data 312 includes an HDL description adding a new function β to the circuit element B by replacing at least a part of the HDL description expressing the circuit element B, and an HDL description of adding a new function γ to the circuit element C by replacing at least of the HDL description expressing the circuit element C. Further, the RTL circuit data 312 also includes an HDL description adding a new function δ to the module MC by replacing at least a part of the HDL description expressing the module MC.

The functions α, ε, γ, and δ to be added are, for example, clock gating. By adding the clock gating function, power consumption of the semiconductor integrated circuit expressed by the RTL circuit data 312 can be reduced.

At the time of performing the logic synthesis of the RTL circuit data 312, the CPU 301 in FIG. 1 can select either the case of logic-synthesizing the HDL description expressing the circuit elements A, B, and C and the module MC without adding the functions α, β, γ, and δ and the case of replacing corresponding parts in the HDL descriptions expressing the functions α, β, γ, and δ and performing logic synthesis. Whether each of the functions α, β, γ, and δ is added or not is determined in accordance with selection information which is preliminarily given from the user.

In the design data 310 of the semiconductor integrated circuit, the selection information 313 is included in advance. For example, in the case of FIG. 3, switches SW1, SW2, SW3, and SW4 are determined as selection information (the switches in this case are not physical switches but denote parameters or the like expressing the selection information). In the case where the switch SW1 is “0”, the HDL description expressing only the circuit element A to which the function α is not added is selected. In the case where the switch SW1 is “1”, a circuit obtained by replacing at least a part of the HDL description expressing the circuit element A with the HDL description expressing the function α is selected. The other switches SW2, SW3, and SW4 are similar to the above. In the case where the functions α, β, γ, and δ are functions to reduce power consumption such as clock gating, by selecting “1” for all of the switches SW1 to SW4, the power consumption of the semiconductor integrated circuit can be reduced most.

In the case where the verilog-HDL is used as the hardware description language, by using a compiler instruction directive by which a code to be compiled according to whether a macro name is defined or not, whether the function α, β, γ, or δ is added or not can be selected. In this case, macro names correspond to the switches SW1 to SW4.

By configuring the data structure of the design data of the semiconductor integrated circuit as described above, only by changing the design of the switches SW1 to SW4 in accordance with the design specifications such as power consumption and operation frequency, the design of a specific circuit element can be easily changed. Therefore, by providing a soft macro of the data structure from the vendor, the user of the soft macro can easily customize the soft macro at low cost and low risk in accordance with the design specification.

### Second Embodiment

In a second embodiment, a concrete example of the data structure of the design data of the semiconductor integrated circuit descried in the first embodiment will be described.

### Clock Gating

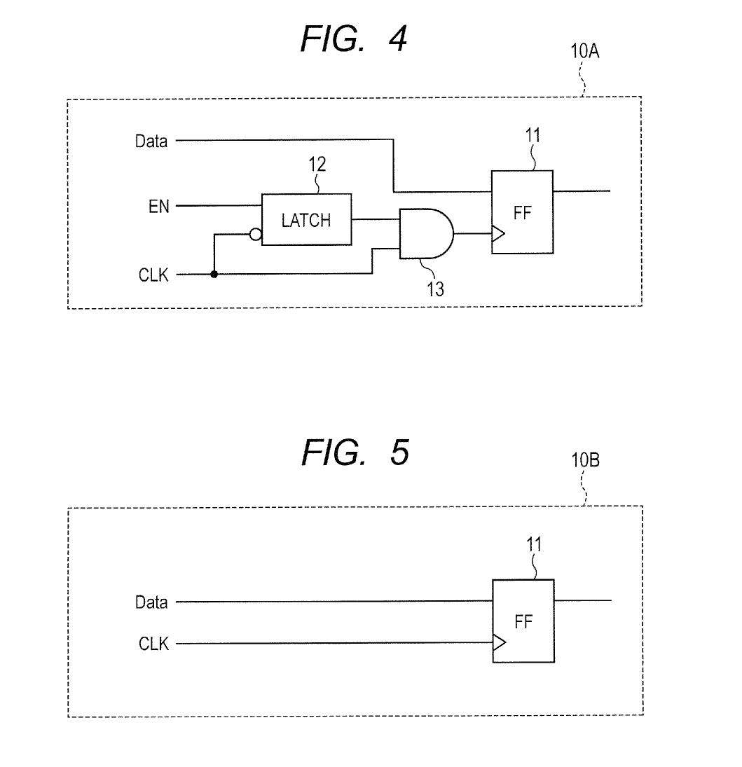

FIG. 4 is a circuit diagram in the case of performing clock gating to a flip flop. FIG. 5 is a circuit diagram of a free-running flip flop to which clock gating is not performed.

Referring to FIG. 5, in the case where the clock gating is not performed, an output signal (FF) of a flip flop 11 becomes equal to a data signal DATA at the rising edge of a clock signal CLK. Further, at the falling edge of a not-illustrated reset signal RST_n, the output signal (FF) of the flip flop 11 becomes equal to “0”.

Referring to FIG. 4, a circuit 10A in the case of performing the clock gating is different from a circuit 10B in FIG. 5 with respect to the point that a latch circuit (LATCH) 12 and an AND gate 13 are included in addition to the flip flop 11. The latch circuit 12 holds an enable signal EN at the falling edge of the clock signal CLK. The AND gate 13 outputs a logical sum between the output signal of the latch circuit 12 and the clock signal CLK to the flip flop 11. In the case where the enable signal EN held in the latch circuit 12 is “1” (that is, when the output signal of the latch circuit 12 is “1”), the output signal (FF) of the flip flop 11 becomes equal to the data signal Data at the rising edge of the clock signal CLK. In the case where the enable signal EN held in the latch circuit 12 is “0”, the output signal (FF) of the flip flop 11 is not updated.

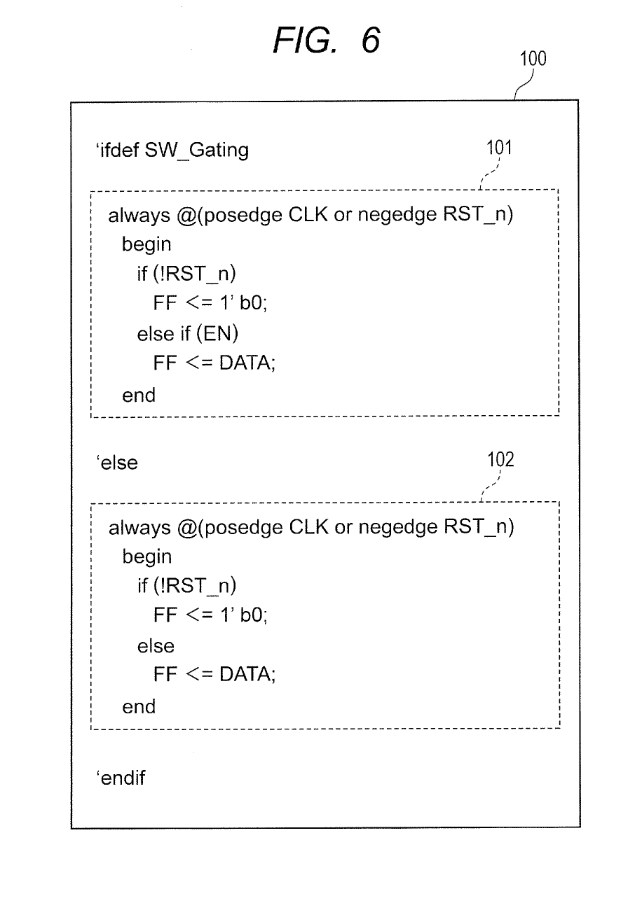

FIG. 6 is a diagram illustrating an example of HDL descriptions which can be selected by the circuit of FIG. 4 and the circuit of FIG. 5. In the specification, as the HDL, the Verilog HDL (Verilog Hardware Description Language) is used. In place of the Verilog HDL, another HDL such as SystemVerilog System, SystemC, or VHDL may be used.

Referring to FIG. 6, an example of describing the circuit 10A in FIG. 4 in the Verilog HDL is an HDL description 101. An example of describing the circuit 10B in FIG. 5 is an HDL description 102. In an HDL description 100, both of the HDL descriptions 101 and 102 having the same input signals (that is, the clock signal CLK and a reset signal RST_n) are described. In a compiler directive for conditional compilation expressed by “`ifdef˜`else˜`. endif”, depending on whether a macro name (SW_Gating) is defined or not, one of the HDL descriptions can be selected. Concretely, when “`define SW_Gating” is described in the design data, the HDL description 101 is selected at the time of compilation. When “`define SW_Gating” is not described in the design data, the HDL description 102 is selected. That is, in the case where a macro name (SW_Gating) is described, by replacing the HDL description 102 expressing the register (flip flop) 11 illustrated in FIG. 5 with the HDL description 101, the clock gating function is added to the register.

The HDL description 101 or 102 can be also selected without using a compiler directive for conditional compilation. For example, the HDL descriptions 101 and 102 are formed as modules and are stored in different files. After that, in the case of using an EDA (Electronic Design Automation) tool such as Verilog simulator or logic synthetic tool, by a method of reading a desired module file before an HDL description file is read, an HDL description can be selected.

Although the clock gating for a logic circuit such as a flip flop is described in the above example, clock gating for a circuit at a module level such as a memory is also possible. Also in this case, in a manner similar to the above, either a module to which clock gating is performed or a module to which clock gating is not performed can be selected, and the selected module is compiled.

Hereinbelow, the effect of the above will be described. By providing a function that a user of a soft macro can select a circuit using the clock gating and a circuit using no clock gating, realization of higher speed is facilitated in a semiconductor integrated circuit requested to have higher speed and realization of lower power consumption is facilitated in a semiconductor integrated circuit requested to have lower power consumption.

For example, when the control signal EN controlling the clock gating does not satisfy timing limitation of setup time of the circuit 10A due to a signal propagation delay or the like, by selecting the HDL description 102 in FIG. 6, the clock gating is stopped. By stopping the clock gating, one stage of agate can be omitted. Consequently, propagation time of the control signal EN can be shortened.

On the contrary, in the case where the operation frequency of a semiconductor integrated circuit mounted is low, there is a margin in the operation timing. In such a case, by selecting the HDL description 101 in FIG. 6, lower power consumption by the clock gating can be realized.

### Operand Isolation

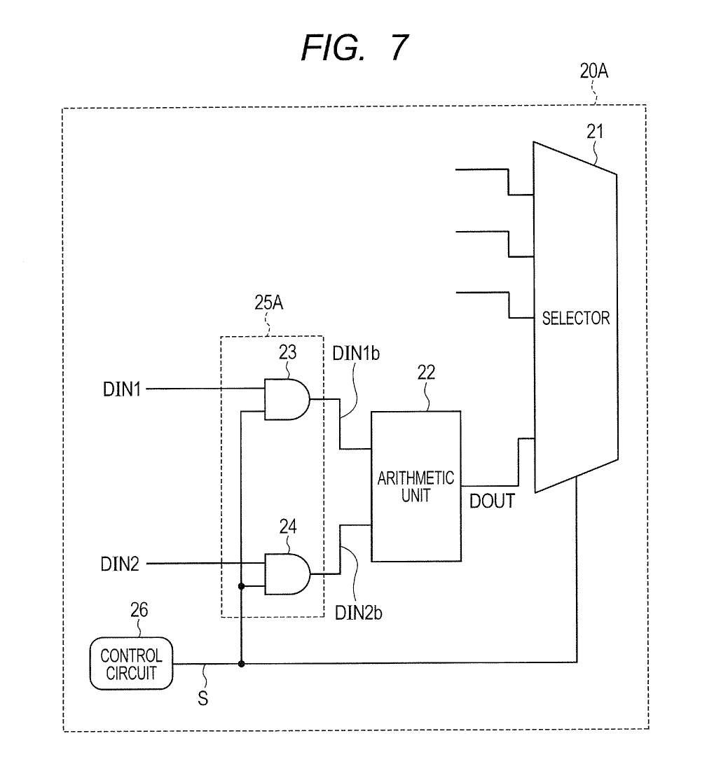

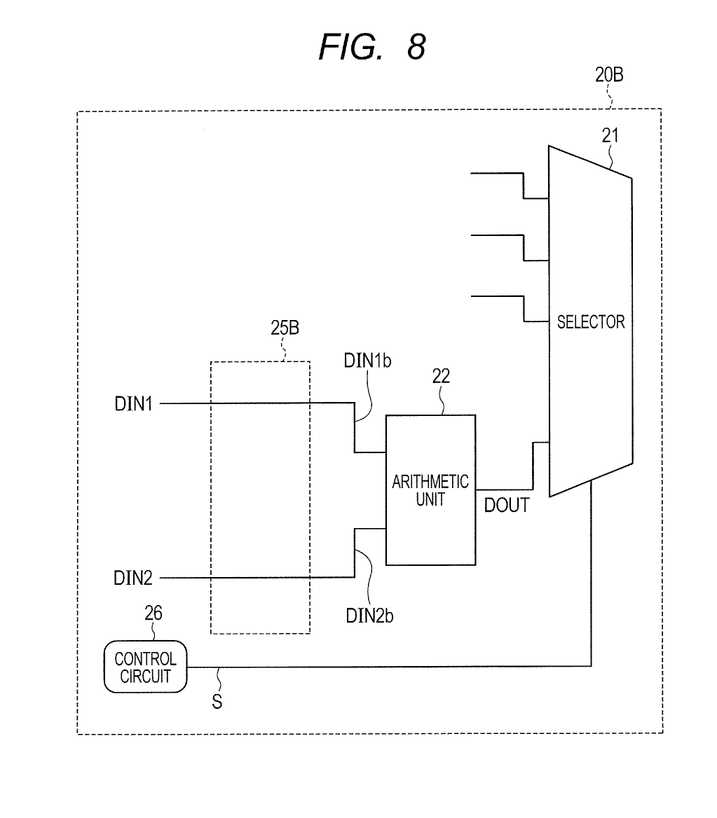

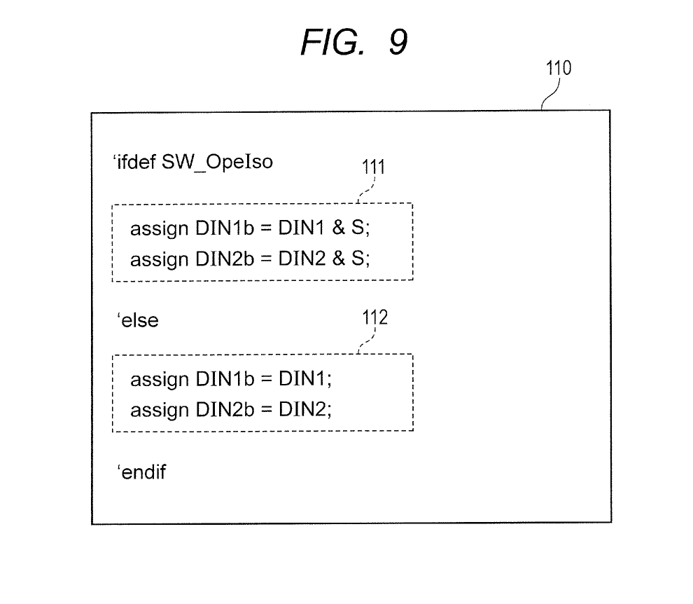

FIG. 7 is a circuit diagram illustrating an example of the case of performing operand isolation on input data of an arithmetic unit. FIG. 8 is a circuit diagram illustrating an example of the case where operand isolation is not performed on input data of the arithmetic unit. In a circuit 20A of FIG. 7 and a circuit 20B of FIG. 8, a part of a data path of circuits performing data process such as a data path of a CPU (Central Processing Unit) is illustrated.

The circuit 20B of FIG. 8 includes a selector 21, an arithmetic unit 22, and a control circuit 26. The arithmetic unit 22 performs arithmetic operation on input signals DIN1b and DIN2b (equal to original input signals DIN1 and DIN2, respectively) and outputs an arithmetic operation result DOUT to the selector 21. According to a control signal S output from the control circuit 26, the selector 21 selects and outputs any one of a plurality of input signals.

The circuit 20A of FIG. 7 is different from the circuit 20B of FIG. 8 with respect to the point that a circuit 25A for performing operand isolation to the original input signals DIN1 and DIN2 of the arithmetic unit 22. The circuit 25A for operand isolation includes AND gates 23 and 24. The AND gate 23 outputs a result of AND operation of the original input signal DIN1 and the control signal S as an actual input signal DIN1b to the arithmetic unit 22. The AND gate 24 outputs a result of AND operation of the original input signal DIN2 and the control signal S as an actual input signal DIN2b to the arithmetic unit 22.

In the case where the control signal S is “1” and the output signal DOUT of the arithmetic unit 22 is selected by the selector 21 in the configuration of the circuit 20A, the original input signals DIN1 and DIN2 are supplied as they are to the arithmetic unit 22. In the case where the control signal S is “0” and the output signal DOUT of the arithmetic unit 22 is not selected by the selector 21, the actual input signals DIN1a and DIN2b of the arithmetic unit 22 become equal to “0”.

It can be considered that the circuit 20B of FIG. 8 is provided with the circuit 25B for outputting, as the actual input signals DIN1b and DIN2b, the original input signals DIN1 and DIN2 as they are to the arithmetic unit 22.

FIG. 9 is a diagram illustrating an example of HDL descriptions which can be selected by the circuit 25A in FIG. 7 and the circuit 25B in FIG. 8. Referring to FIG. 9, an example of describing the circuit 25A in FIG. 7 in the Verilog HDL is an HDL description 111. An example of describing the circuit 25B in FIG. 8 in the Verilog HDL is an HDL description 112. In the HDL description 110, both the HDL descriptions 111 and 112 having the same input signals DIN1 and DIN2 are described. In a compiler directive for conditional compilation expressed by “`ifdef˜`else˜`endif”, when the macro name (SW_OpeIso) is defined, the HDL description 111 is selected, and when the macro name (SW_OpeIso) is not defined, the HDL description 112 is selected. That is, in the case where the macro name (SW_OpeIso) is defined, by replacing the HDL description 112 as apart of the HDL description expressing the circuit 20B in FIG. 8 with the HDL description 111, the clock isolation function is added.

As described above, the HDL descriptions 111 and 112 can be also selected without using the compiler directive for conditional compilation. For example, it is sufficient to form the HDL descriptions 111 and 112 as modules, store the modules as different files and, at the time of compiling, read a desired module file.

By providing the function that a user of a soft macro can select a circuit using operand isolation and a circuit using no operand isolation as described above, optimization of the semiconductor integrated circuit is facilitated. That is, by not employing operand isolation in a semiconductor integrated circuit which is requested to have higher speed, higher speed can be easily realized. By employing operand isolation in a semiconductor integrated circuit required to have lower power consumption, lower power consumption can be easily realized.

Concretely, in the circuit 20A in FIG. 7, in the case where the arithmetic unit 22 is not used by employing operand isolation, the input signal of the arithmetic unit 22 is fixed to the low level (“0”) by using the AND gates 23 and 24 in the front stage (the input signal may be also fixed to the high level (“1”) by using an OR gate), so that power consumption of the arithmetic unit 22 further decreases. However, the number of gate stages increases by one due to the AND gates 23 and 24, so that delay time increases, and it becomes difficult to realize high-speed operation only by the amount of the delay time.

### Gating of Address and Data of Memory Circuit

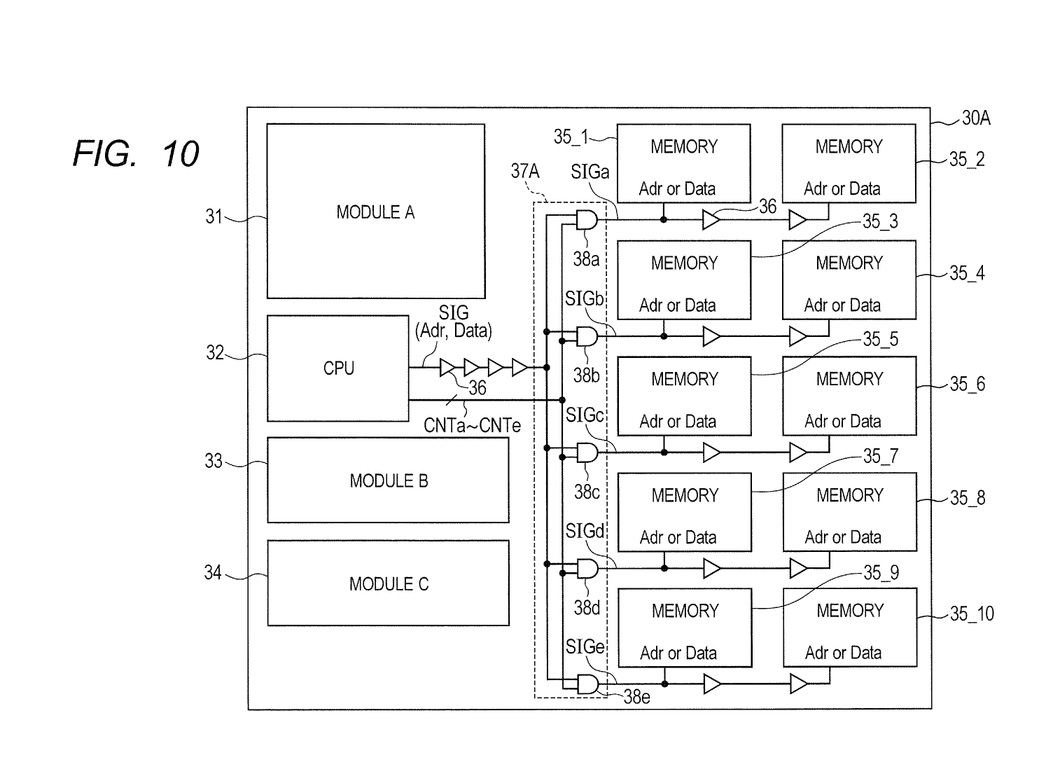

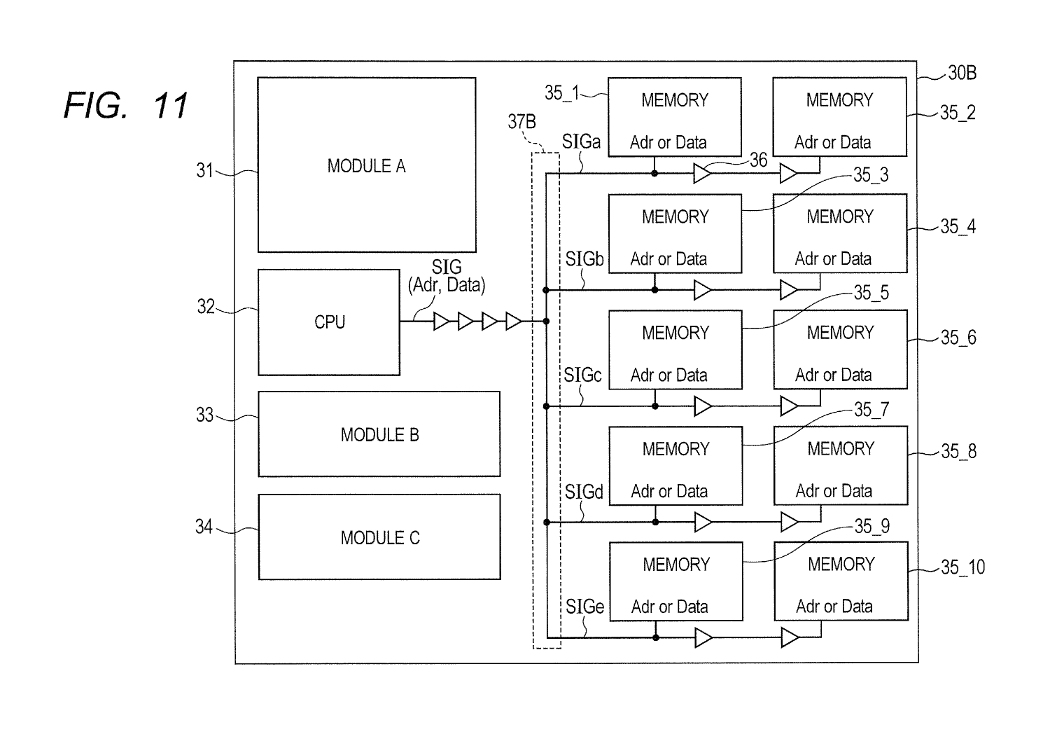

FIG. 10 is a circuit diagram illustrating an example of the case of performing gating of an address and data input to a memory. FIG. 11 is a circuit diagram illustrating an example of the case where gating of an address and data input to a memory is not performed.

A circuit 30B of FIG. 11 is a semiconductor integrated circuit including a CPU 32, modules A, B, and C (31, 33, and 34), and memories 35_1 to 35_10. An output signal SIG (at least one of an address Adr and data Data) of the CPU 32 is branched to signals SIGa to SIGe. It can be considered that the circuit 30B is provided with a circuit 37B for branching the output signal SIG to a plurality of signals. The branched signal SIGa is input to the memories 35_1 and 35_2, the signal SIGb is input to the memories 35_3 and 35_4, the signal SIGc is input to the memories 35_5 and 35_6, the signal SIGd is input to the memories 35_7 and 35_8, and the signal SIGe is input to the memories 35_9 and 35_10. The circuit 30B is also provided with a buffer circuit 36 for amplifying the signals SIG and SIGa to SIGe.

On the other hand, a circuit 30A of FIG. 10 differs from the circuit 30B of FIG. 11 with respect to the point that a circuit 37A for gating an input signal of a memory is also included. The circuit 37A for gating includes AND gates 38a to 38e. The AND gate 38a outputs a result of AND arithmetic operation between the output signal SIG and a control signal CNTa output from the CPU 32 as a signal SIGa to the memories 35_1 and 35_2. Similarly, the AND gate 38b outputs a result of AND arithmetic operation between the output signal SIG and a control signal CNTb as a signal SIGb to the memories 35_3 and 35_4. The AND gate 38c outputs a result of AND arithmetic operation between the output signal SIG and a control signal CNTc as a signal SIGc to the memories 35_5 and 35_6. The AND gate 38d outputs a result of AND arithmetic operation between the output signal SIG and a control signal CNTd as a signal SIGd to the memories 35_7 and 35_8. The AND gate 38e outputs a result of AND arithmetic operation between the output signal SIG and a control signal CNTe as a signal SIGe to the memories 35_9 and 35_10.

With the configuration of the circuit 30A, depending on which one of the control signals CNTa to CNTe is set to “1”, gating of the output signal SIG becomes possible. For example, when the control signal CNTa is set to “1” and the other control signals CNTb to CNTe are set to “0”, the output signal SIG is supplied to the memories 35_1 and 35_2 and is not supplied to the other memories 35_3 to 35_10.

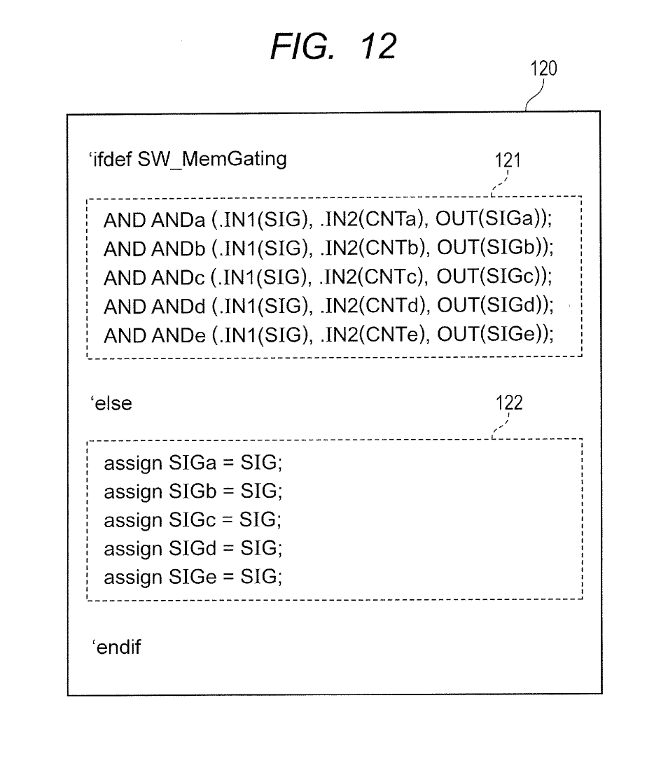

FIG. 12 is a diagram illustrating an example of HDL descriptions which can be selected by the circuit 37A in FIG. 10 and the circuit 37B in FIG. 11. Referring to FIG. 12, an example of describing the circuit 37A in FIG. 10 in the Verilog HDL is an HDL description 121. An example of describing the circuit 37B in FIG. 11 in the Verilog HDL is an HDL description 122.

In an HDL description 120, both the HDL descriptions 121 and 122 having the same input signal SIG are described. In a compiler directive for conditional compilation expressed by “`ifdef˜`else˜`endif”, when a macro name (SW_MemGating) is defined, the HDL description 121 is selected, and when the macro name (SW_MemGating) is not defined, the HDL description 122 is selected. That is, in the case where the macro name (SW_MemGating) is defined, by replacing a part 122 of the HDL description expressing the circuit 30A including the plurality of memories 35_1 to 35_10 with the HDL description 121, the data and address gating function is added.

As described above, the HDL descriptions 121 and 122 can be also selected without using the compiler directive for conditional compilation. For example, it is sufficient to form the HDL descriptions 121 and 122 as modules, store the modules as different files and, at the time of compiling, read a desired module file.

By providing the function that a user of a soft macro can select a circuit gating an address and/or data and a circuit which cannot perform gating as described above, optimization according to a condition of mounting the semiconductor integrated circuit is facilitated. That is, by not employing gating in a semiconductor integrated circuit which is requested to have higher speed, higher speed can be easily realized. By employing gating in a semiconductor integrated circuit required to have lower power consumption, lower power consumption can be easily realized.

Concretely, in the circuit 30A in FIG. 10, by stopping supply of an address and/or data to a memory module which is not accessed, power consumption in the memory module which is not accessed can be reduced. However, signal propagation delay increases by the amount of a gating cell, so that optimization of tradeoff between operation speed and power consumption is necessary according to the limitation of timings.

### Bypass of Data Path

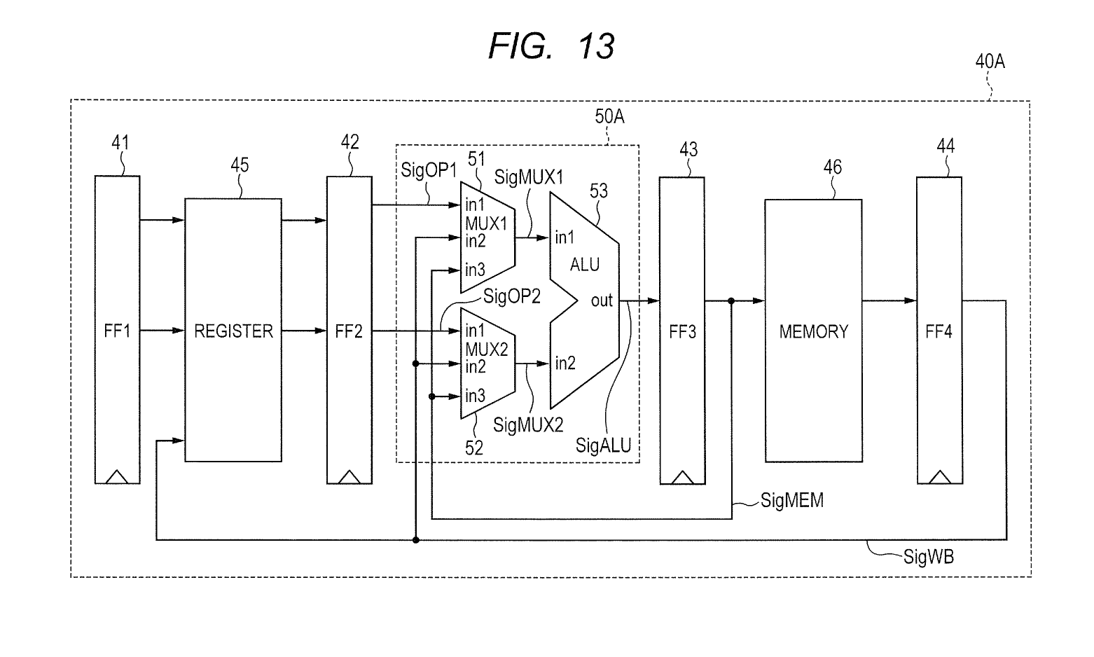

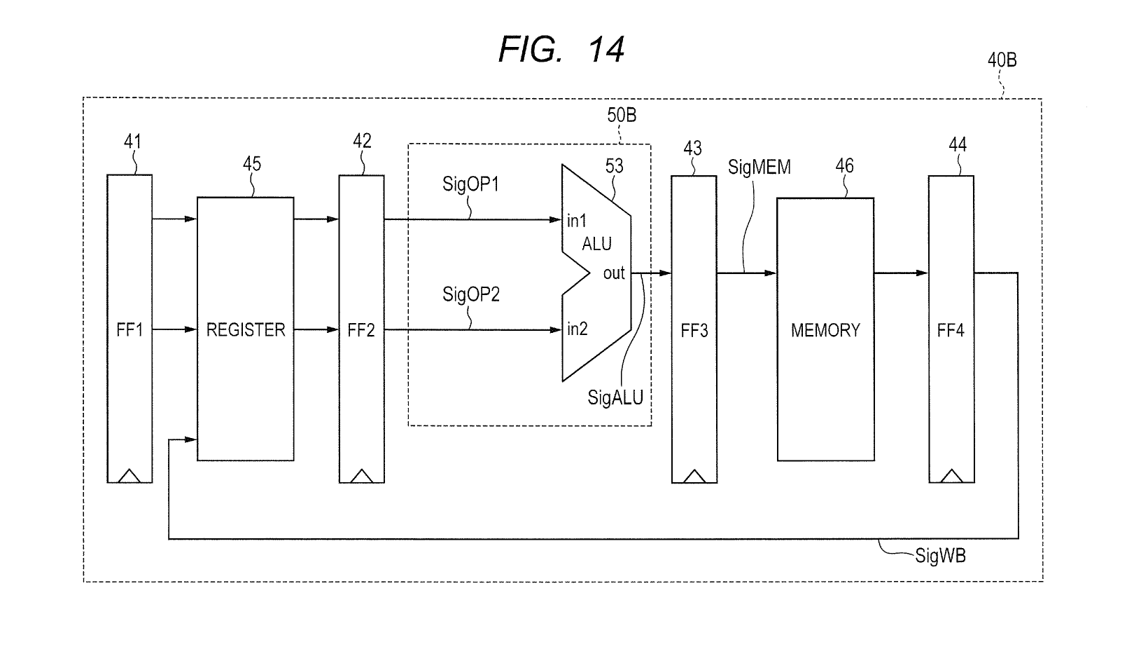

FIG. 13 is a circuit diagram illustrating an example of the case of providing a bypass path of arithmetic data in a data path of a CPU. FIG. 14 is a circuit diagram illustrating an example of the case where a bypass path of arithmetic data is not provided in the data path of the CPU.

A circuit 40B of FIG. 14 illustrates an example of a CPU performing a pipeline process and includes flip flops (FF1 to FF4) 41 to 44, a register 45, a memory 46, and an ALU (Arithmetic Logic Unit) 53. Data SigOP1 and SigOP2 read from the register 45 is input to input nodes in1 and int2, respectively, of the ALU 53 via the flip flop 42. The ALU 53 performs arithmetic operation by using the data SigOP1 and SigOP2 and outputs a result of the arithmetic operation from an output node “out”. Data SigALU output from the ALU 53 is written into the memory 46 via the flip fop 43. Further, data SigWB read from the memory 46 is written into the register 45 via the flip flop 44.

A circuit 40A of FIG. 13 differs from the circuit 40B of FIG. 14 with respect to the point that a bypass path (forwarding path) for inputting the data SigMEM before being written into the memory 46 and the data SigWB before being written into the register 45 into the ALU 53. Further, an arithmetic stage 50A in the circuit 40A of FIG. 13 differs from an arithmetic stage 50B in the circuit 40B of FIG. 14 with respect to the point that multipliers (MUX1 and MUX2) 51 and 52 are included in addition to the ALU 53. The multiplexer (MUX1) 51 has input nodes in1, in2, and in3 to which the data SigOP1, SigWB, and SigMEM are input, selects one of the input data, and supplies the selected data SigMUX1 to the input node in1 of the ALU 53. Similarly, the multiplexer (MUX2) 52 has input nodes in1, in2, and in3 to which the data SigOP2, SigWB, and SigMEM is input, selects one of the input data, and supplies the selected data SigMUX2 to the input node in2 of the ALU 53. The ALU 53 performs arithmetic operation by using the data SigMUX1 and SixMUX2 input to the input nodes in1 and in2, and outputs a result of the arithmetic operation from the output node “out”.

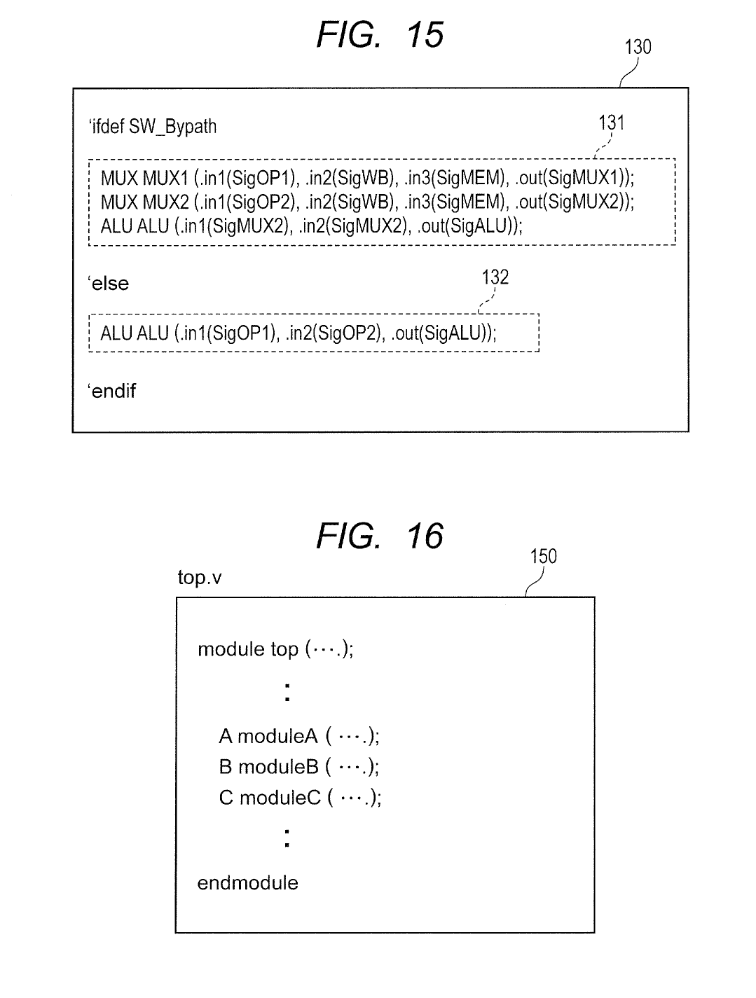

FIG. 15 is a diagram illustrating an example of HDL descriptions which can be selected by the arithmetic stage 50A in FIG. 13 and the arithmetic stage 50B in FIG. 14. Referring to FIG. 15, an example of describing the arithmetic stage 50A in FIG. 13 in the Verilog HDL is an HDL description 131. An example of describing the arithmetic stage 50B in the Verilog HDL is an HDL description 132. In the HDL descriptions 131 and 132, a submodule (module name: MUX) expressing a multiplexer and a submodule (module name: ALU) expressing an ALU are assembled.

In an HDL description 130, both the HDL descriptions 131 and 132 having the same input signals SigOP1 and SigOP2 are described. In a compiler directive for conditional compilation expressed by “`ifdef˜`else˜`endif”, when a macro name (SW_Bypath)is defined, the HDL description 131 is selected, and when the macro name (SW_Bypath) is not defined, the HDL description 132 is selected. That is, in the case where the macro name (SW_Bypath) is defined, by replacing the HDL description 132 expressing the ALU 53 illustrated in FIG. 14 with the HDL description 131, the data forwarding function is added.

As described above, the HDL descriptions 131 and 132 can be also selected without using the compiler directive for conditional compilation. For example, it is sufficient to form the HDL descriptions 131 and 132 as modules, store the modules as different files and, at the time of compiling, read a desired module file.

To execute an arithmetic operation in the ALU 53 in the circuit 40B in FIG. 14 corresponding to the HDL description 132, data written once in the memory 46 and the register 45 has to be read. Consequently, completion of the writing of the data to the register 45 and the memory 46 being executed in accordance with a preceding instruction has to be waited.

On the other hand, in the circuit 40A in FIG. 13 corresponding to the HDL description 131, the data SigMEM and SigWB before being written in the memory 46 and the register 45 is bypassed to the input nodes in1 and in2 of the ALU 53 via the multiplexers (MUX1 and MUX2) 51 and 52. Consequently, without waiting for completion of writing of data into the register 45 and the memory 46 being executed in accordance with a preceding instruction, an arithmetic operation according to the next instruction can be executed in the ALU 53. However, a problem of increase in delay time of data which is input to the ALU 53 and increase in the circuit area occurs due to addition of the multiplexers 51 and 52, the tradeoffs among frequency, area, power, cycle performance, and the like have to be judged.

As described above, by providing the function that a user of a soft macro can select a circuit to which the bypass path is added and the circuit in which no bypass is performed in the pipeline circuit, optimization according to a condition of mounting the semiconductor integrated circuit is facilitated. Concretely, in a semiconductor integrated circuit which is requested to have higher speed more than improvement of the cycle performance, by selecting a pipeline circuit in which bypass using a forwarding path is not performed, higher speed can be easily realized. On the contrary, in a semiconductor integrated circuit required to have high cycle performance, by selecting a pipeline circuit in which bypassing is performed by using a forwarding path, the cycle performance can be easily improved. On the other hand, in a semiconductor integrated circuit in which priority is placed on reduction in area and power consumption over cycle performance and operation speed, by selecting a pipeline circuit in which bypass using a forward path is not performed and decreasing the operation frequency, reduction in area and power consumption can be preferentially realized.

### Example of Design Data of Semiconductor Integrated Circuit

Hereinbelow, referring to FIGS. 16 to 20, an example of design data of a semiconductor integrated circuit obtained by combining the above HDL descriptions will be described. In the following example, the clock gating function described with reference to FIGS. 4 to 6, the operand isolation function described with reference to FIGS. 7 to 9, and the gating function on an address and data for a memory described with reference to FIGS. 10 to 12 can be selected.

In the following example, although the top module, modules A, B, and C, and the macro definition are set in individual files (the file names are “top.v”, “A.v”, “B.v”, “C.v”, and “top.def”, respectively), they may be also set in the same file.

FIG. 16 is a diagram illustrating an example of an HDL description of a top module (fine name: top.v). The top module of FIG. 16 corresponds to the module TM in FIG. 3. In the case of FIG. 16, submodules A, B, and C are assembled in the top module.

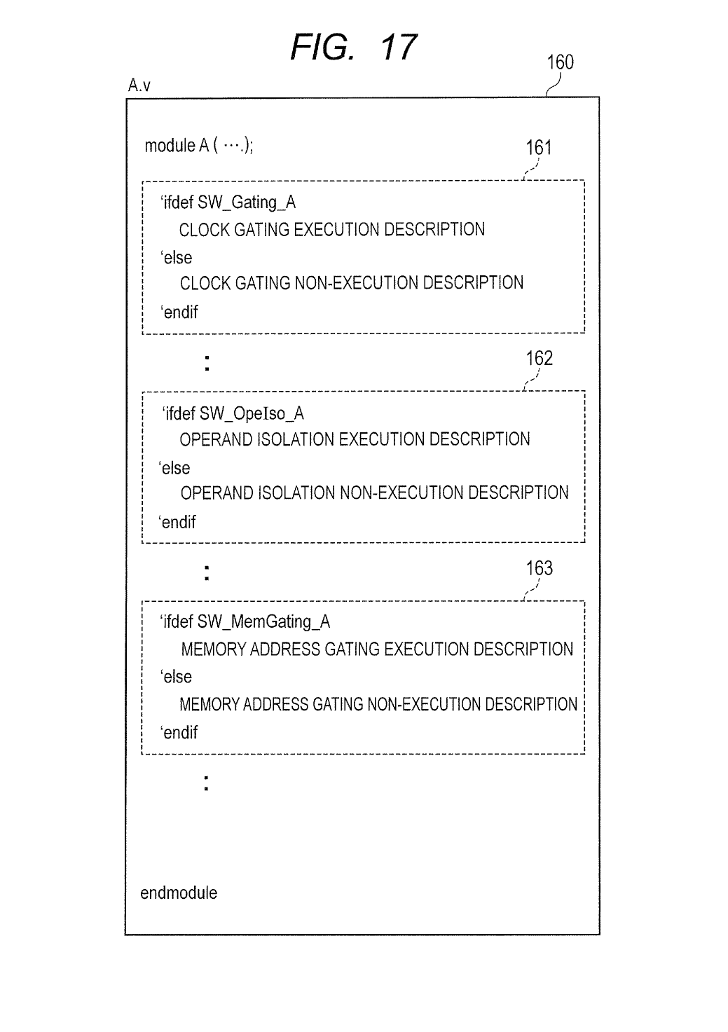

FIG. 17 is a diagram illustrating an HDL description example of the module A assembled in the top module of FIG. 16. Referring to FIG. 17, an HDL description 160 of the module A includes a plurality of HDL descriptions (161 to 163) having an option by a compiler directive for conditional compilation.

Concretely, in the HDL description 161, both of two HDL descriptions (clock gating execution description and clock gating non-execution description) are written. The HDL descriptions are selectively compiled depending on whether macro name SW_Gating_A is defined or not. The HDL description 161 corresponds to the HDL description 100 in FIG. 6.

In the HDL description 162, both of two HDL descriptions (operand isolation execution description and operand isolation non-execution description) are written. The HDL descriptions are selectively compiled depending on whether macro name SW_OpeIso_A is defined or not. The HDL description 162 corresponds to the HDL description 110 in FIG. 9.

In the HDL description 163, both of two HDL descriptions (memory address gating execution description and memory address gating non-execution description) are written. The HDL descriptions are selectively compiled depending on whether macro name SW_MemGating_A is defined or not. The HDL description 163 corresponds to the HDL description 120 in FIG. 12.

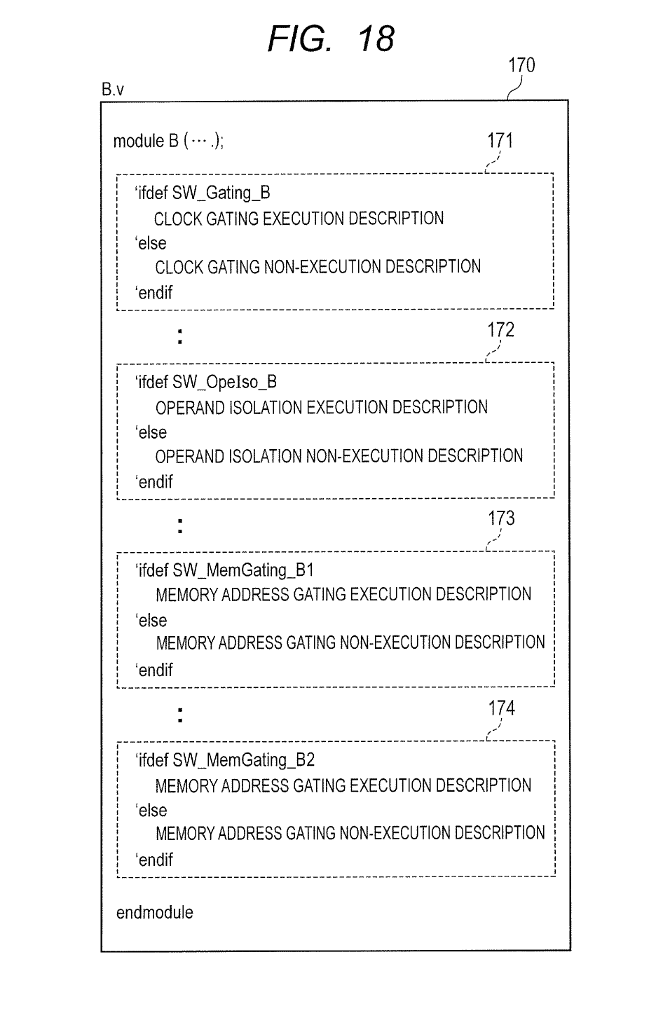

FIG. 18 is a diagram illustrating an HDL description example of the module B assembled in the top module of FIG. 16. In an HDL description 170 of the module B in FIG. 18, a plurality of HDL descriptions (171 to 174) having an option by a compiler directive for conditional compilation exist.

Concretely, in the HDL description 171, both of two HDL descriptions (clock gating execution description and clock gating non-execution description) are written. The HDL descriptions are selectively compiled depending on whether macro name SW_Gating_B is defined or not.

In the HDL description 172, both of two HDL descriptions (operand isolation execution description and operand isolation non-execution description) are written. The HDL descriptions are selectively compiled depending on whether macro name SW_OpeIso_B is defined or not.

In each of the HDL descriptions 173 and 174, both of two HDL descriptions (memory address gating execution description and memory address gating non-execution description) are written. The HDL descriptions are selectively compiled depending on whether macro name SW_MemGating_B1 or B2 (corresponding to the HDL description 173 or 174) is defined or not.

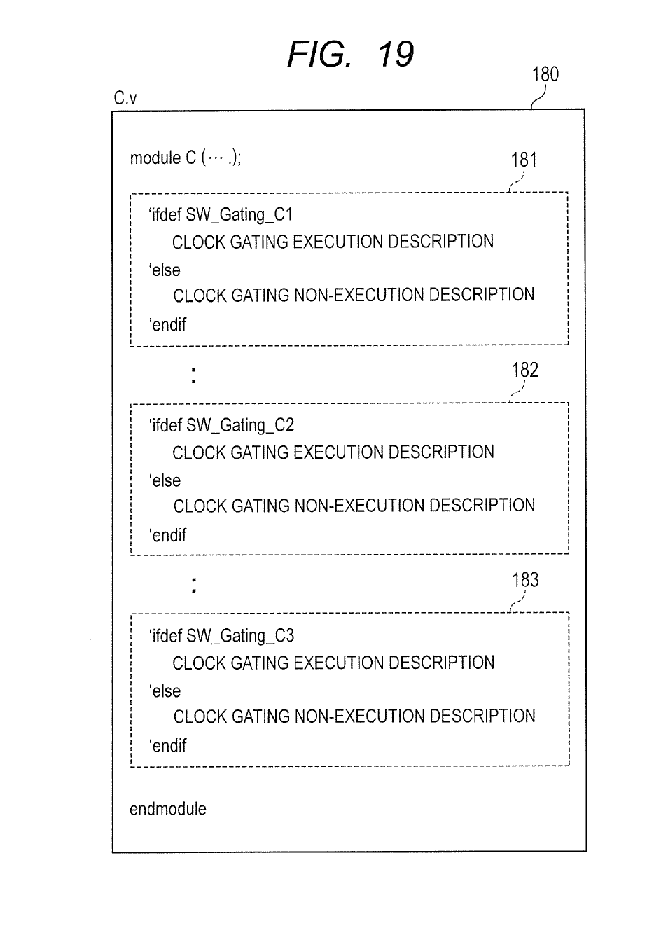

FIG. 19 is a diagram illustrating an HDL description example of the module C assembled in the top module of FIG. 16. In an HDL description 180 of the module C in FIG. 19, a plurality of HDL descriptions (181 to 183) having an option by a compiler directive for conditional compilation exist.

Concretely, in each of the HDL descriptions 181 to 183, both of two HDL descriptions (clock gating execution description and clock gating non-execution description) are written. The HDL descriptions are selectively compiled depending on whether macro name SW_Gating_C1, C2, or C3 (corresponding to the HDL description 181, 182, or 183) is defined or not.

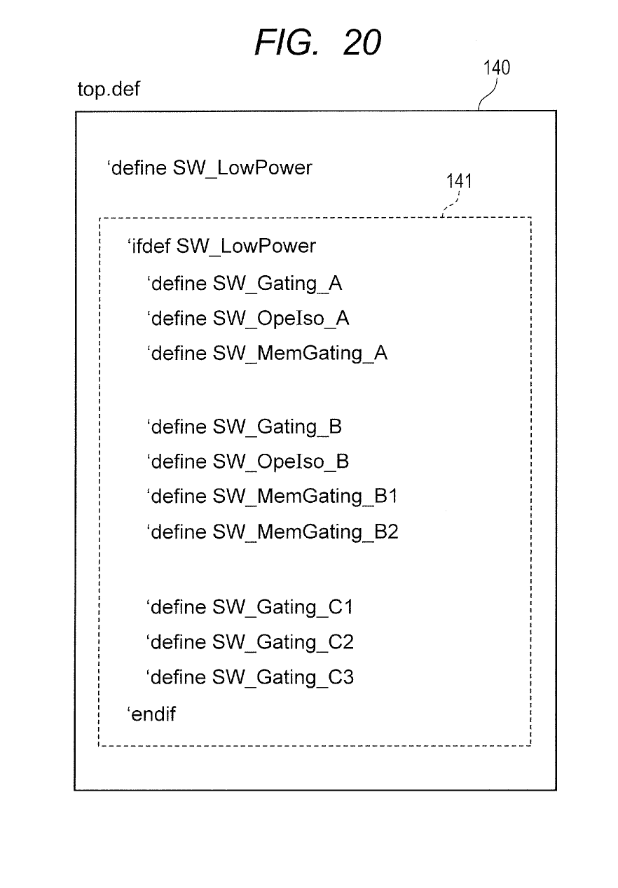

FIG. 20 is a diagram illustrating a description example of macro definition. A description 140 of macro definition in FIG. 20 is to define macro names used by compiler directives in FIGS. 17 to 19 and corresponds to selection information 313 in FIG. 3. Particularly, in the case of FIG. 20, by using the compiler directive “`ifdef˜`endif” for conditional compilation, by one kind of the macro name SW_LowPower, all of the macro names SW_Gating_XX, SW_OpeIso_XX, and SW_MemGating_XX described in the modules A, B, and C in FIGS. 17 to 19 can be defined.

In the specification, the macro name “SW_LowPower” is called a main switch, and macro names SW_Gating_XX, SW_OpeIso_XX, and SW_MemGating_XX for selecting respective circuits are called sub-switches. The terms of the main switch and the sub-switch are concept denoting selecting means and are not related to actual switch circuits.

As illustrated in FIG. 20, when “`define SW_LowPower” defining the macro name SW_LowPower is described, at the time of compilation, a clock gating execution description, an operand isolation execution description, and a memory address gating execution description (that is, circuits performing reduction of power consumption) in the modules A, B, and C are selected in a lump. The time of compilation corresponds to, for example, when the files “top.v”, “A.v”, “B.v”, “C.v”, and “top.def” are read in a lump by a Verilog simulator or logic synthesis tool.

On the contrary, when “`define SW_LowPower” defining the macro name SW_LowPower is not described, at the time of compilation, a clock gating non-execution description, an operand isolation non-execution description, and a memory address gating non-execution description (that is, circuits which do not perform reduction of power consumption) in the modules A, B, and C are selected in a lump.

By providing a soft macro with an option of whether circuits for reduction of power consumption are selected or not as descried above, the user to which a soft macro is provided from a vendor can select a circuit (HDL description) matching design specifications and perform optimized implementation in short time and at low risk and low cost.

For example, in the above example, the function of performing description by an HDL description selected by defining the macro name SW_LowPower is effective to lower power consumption but, as delay time increases by addition of the gating, can be a cause of disturbing high-speed operation. Therefore, in the case where the operation frequency is relatively low and the high-speed operation is unnecessary in product specifications of the user, by defining the macro name SW_LowPower, implementation using a circuit in which power consumption is lowered can be realized. On the other hand, in the case where the operation frequency is relatively high and high-speed operation is necessary in product specifications of the user, by not defining the macro name SW_LowPower, implementation using a circuit which can perform high-speed operation (HDL description) can be realized.

All of macro names used in compiler directives in the modules A, B, and C illustrated in FIGS. 17 to 19 can be also changed to “SW_LowPower”. In this case, description in the part indicated by reference numeral 141 in FIG. 20 is unnecessary. Alternatively, in FIG. 20, by deleting “`define SW_LowPower”, “`ifdef SW_LowPower” and “`endif”, macro names SW_Gating_XX, SW_OpeIso_XX, and SW_MemGating_XX may be directly defined.

In the above example, the circuit functions described in FIGS. 4 to 12 are selectable. Naturally, circuits other than the above circuits may be set to be selectable.

### Third Embodiment

As described with reference to FIG. 3 in the first embodiment, for a specific module and a specific circuit element included in the RTL circuit data 312, an HDL description expressing a circuit element to which an additional function is added is provided as another option. At the time of logic synthesis of the RTL circuit data 312, whether an additional function is added or not is selected for each of a specific module or a circuit element in accordance with the selection information 313, and logic synthesis is performed by using the selected HDL description.

In the third embodiment, a new configuration example of the selection information 313 is presented. Concretely, the selection information 313 includes a plurality of selection patterns as a combination of options which can be selected for a specific module or each of circuit elements. The CPU 301 performs logic synthesis of the RTL circuit data 312 in accordance with a pattern selected by the user in a plurality of selection patterns.

Hereinbelow, the third embodiment will be described specifically with reference to the drawings. In the following description, means selecting an option for each specific circuit element will be called a sub-switch SW. According to setting (“0” or “1”) of the sub-switch SW, one of options of a corresponding specific circuit element is selected. Further, according to amain switch, one of a plurality of selection patterns is selected. The sub-switch and the main switch are concept expressing selecting means (for example, a macro name in the case of a Verilog HDL) and are not related to actual switches.

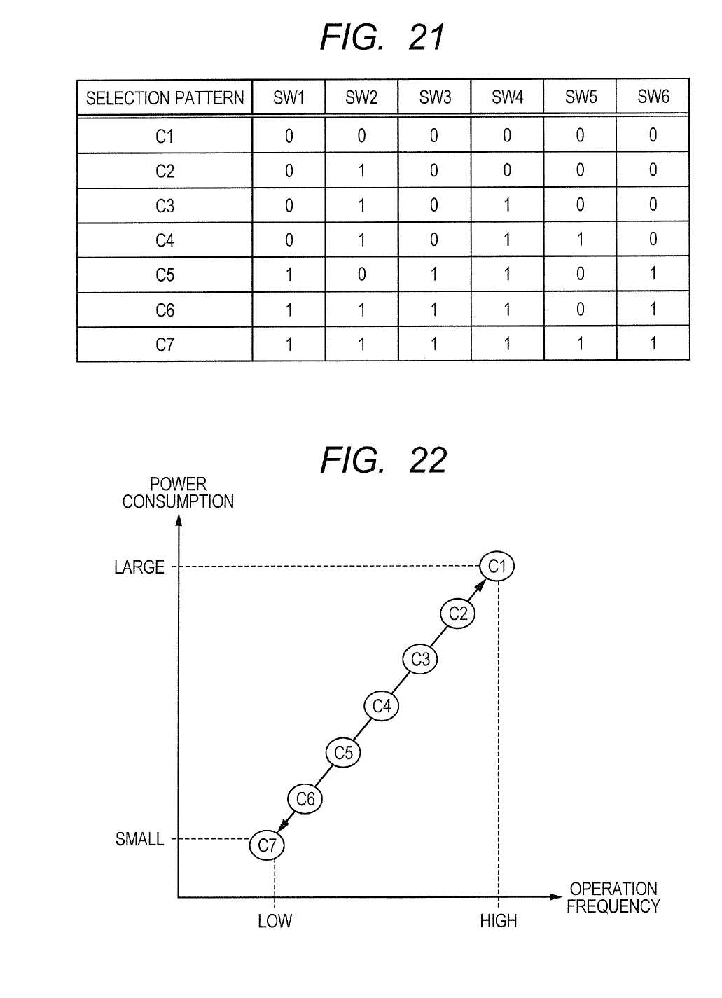

FIG. 21 is a diagram for illustrating selection information used in design data of a semiconductor integrated circuit according to the third embodiment. In the example of FIG. 21, seven selection patterns (main switches) are provided for settings of the sub-switches SW1 to SW6.

For example, in the case where the selection pattern C7 is selected as a main switch, “1” is selected for all of the sub-switches SW1 to SW7. When it is assumed that a circuit element selected in the case where “1” is set for the sub-switch SW is added with a function for reducing power consumption as compared with a circuit element selected in the case where “0” is set for the sub-switch SW, by selecting the selection pattern C7, power consumption of the semiconductor integrated circuit can be reduced most. However, signal delay occurs by the added function, so that the operation frequency becomes the lowest. On the other hand, when the selection pattern C1 is selected as a main switch, “0” is selected for all of the sub-switches SW1 to SW7. In this case, the power consumption of the semiconductor integrated circuit becomes the largest, and the operation frequency can be made highest.

The selection patterns C2 to C6 are intermediate between the selection patterns C1 and C7. In this case, it is desirable to determine a switch SW which is set to “1” and a switch SW which is set to “0” for each selection pattern so that the power consumption and maximum operation frequency of a semiconductor integrated circuit generated from the RTL circuit data 312 change step by step in accordance with the selection patterns.

FIG. 22 is a diagram illustrating the relation between power consumption and operation frequency on each of the selection patterns of FIG. 21. As described above, in the case where the selection pattern C1 is selected as amain switch, power consumption becomes the largest and the maximum operation frequency becomes the highest. In the case where the selection pattern C7 is selected as a main switch, power consumption becomes the smallest and the maximum operation frequency becomes the lowest. It is desirable to set the selection patterns C2 to C6 so that, as illustrated in FIG. 22, maximum operation frequency and power consumption gradually linearly change in accordance with the selection patterns. Consequently, the user can easily customize circuit data in accordance with design specifications such as power consumption and maximum operation frequency.

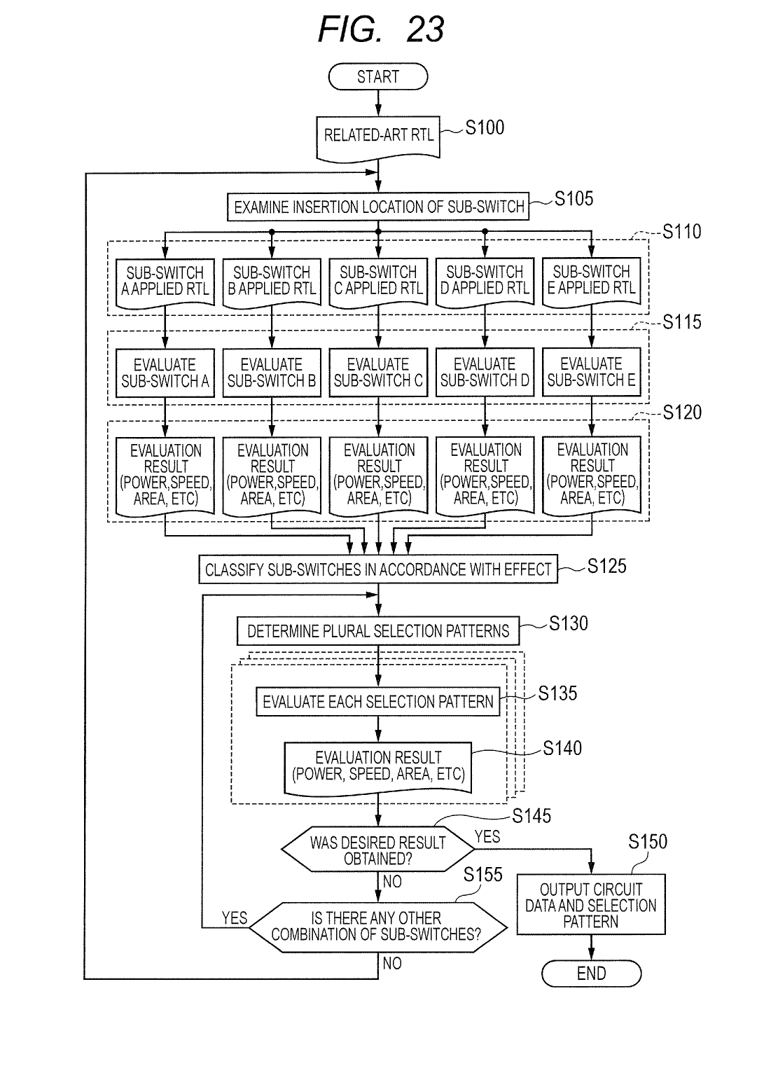

FIG. 23 is a flowchart illustrating a method of generating design data of a semiconductor integrated circuit. In FIG. 23, a method of designing RTL circuit data including an option on a specific circuit element on the basis of related-art RTL circuit data and a method of determining a plurality of selection patterns so that maximum operation frequency and power consumption change step by step are illustrated.

First, on the basis of related-art RTL circuit data (S100), an insertion location of a sub-switch, that is, a location in which a compiler directive for conditional compilation is to be replaced with an alternative HDL description is examined (S105).

Next, on the basis of the examination result, RTL circuit data to which the sub-switches A to E are applied individually is generated (S110), and performance evaluation is performed on each of pieces of the RTL circuit data generated (S115).

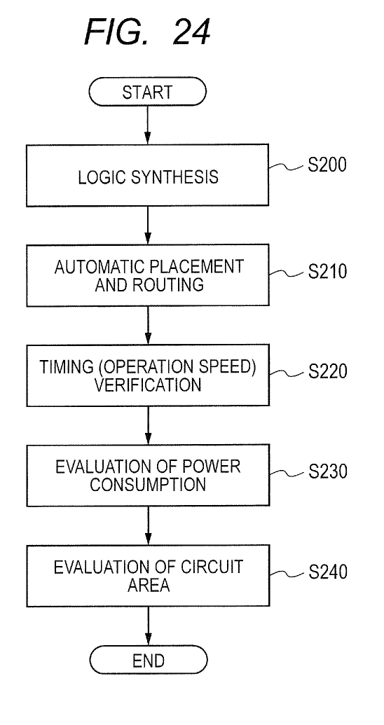

FIG. 24 is a flowchart for more specifically explaining the procedure of step 5115 in FIG. 23. In the following processes are executed by an EDA (Electronic Design Automation) tool. First, logic synthesis (S200) and automatic placement and routing (S210) are performed on the generated RTL circuit data to generate a pattern layout. Next, on the basis of the generated pattern layout, timing verification (S220), evaluation of power consumption (S230), and evaluation of the circuit area (S240) are executed.

Referring again to FIG. 23, on the basis of the effect (S120) of the performance evaluation, according to the degree of effect such as the degree of decrease in power consumption and the degree of decrease in maximum operation frequency, the sub-switches A to E are classified (S125). On the basis of the classification result of the sub-switches A to E, a combination pattern of the sub-switches A to E, that is a selection pattern (main switch) is determined (S130).

Next, on the RTL circuit data to which the determined selection pattern (main switch) is applied, performance evaluation similar to that in step S115 is performed (S135). When the result of the performance evaluation (S140) is a desired result (YES in S145), design data (RTL circuit data and the selection pattern) is output (S150), and the process is finished. In the case where a desired result is not obtained (NO in S145), the program returns to step S130 and the combination of the sub-switches is changed (YES in S155) or the program returns to step S105 and the insertion location of the sub-switch is re-examined (NO in S155).

### Fourth Embodiment

In a fourth embodiment, design data, particularly, selection information of the semiconductor integrated circuit described in the third embodiment will be described by concrete examples. Design data to be described is obtained by changing the HDL description of the module of FIG. 17 and the method of defining the macro name in FIG. 20 in the design data described with reference to FIGS. 16 to 20 in the second embodiment. The HDL description of the top module illustrated in FIG. 16 and the HDL descriptions of the modules B and C described with reference to FIGS. 18 and 19 are unchanged.

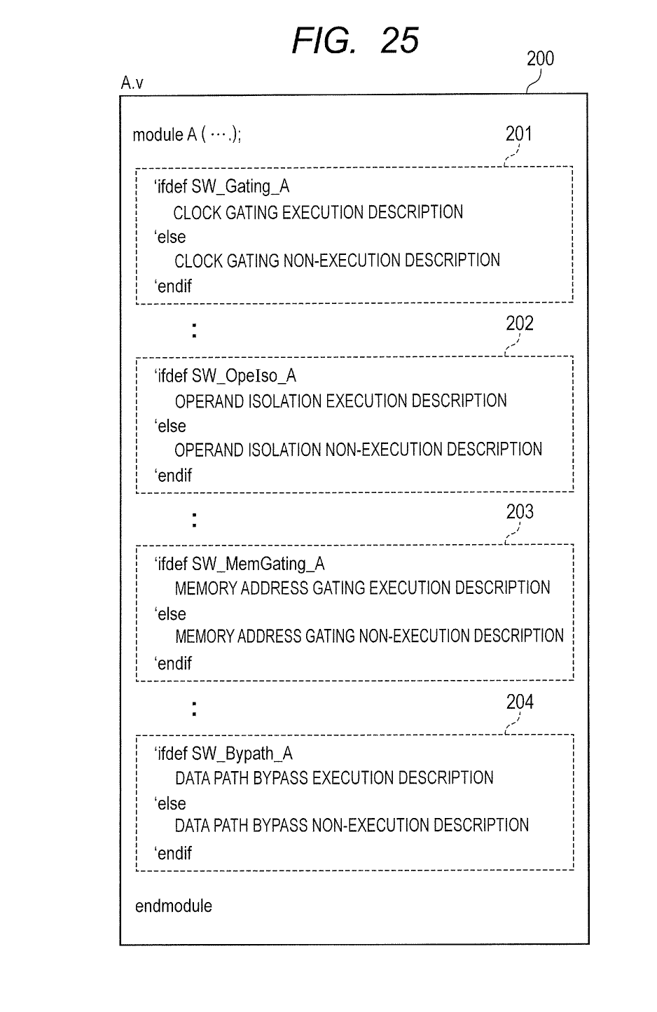

FIG. 25 is a diagram illustrating an HDL description example of the module A in the case of the fourth embodiment. Referring to FIG. 25, an HDL description 200 of the module A includes a plurality of HDL descriptions (201 to 204) each having an option by a compiler directive for conditional compilation. Since the HDD descriptions 201 to 203 are the same as the HDL descriptions 161 to 163 in FIG. 17, their description will not be repeated.

In the HDL description 204, two HDL descriptions (data bypass execution description and data path bypass non-execution description) are written. The HDL descriptions are selectively compiled in accordance with whether the macro name SW_Bypath_A is defined or not. The HDL description 204 corresponds to the HDL description 130 in FIG. 15.

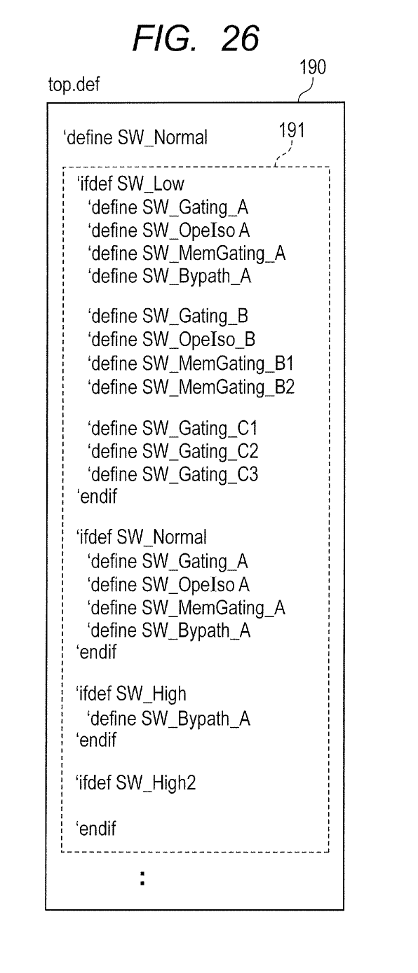

FIG. 26 is a diagram illustrating a description example of macro definition in the case of the fourth embodiment. A description 190 of macro definition of FIG. 26 corresponds to the selection information 313 in FIG. 3.

The characteristic of the description 190 of macro definition illustrated in FIG. 26 is that only a selected macro name from the macro names used in the compiler directive described in the module A in FIG. 25, the macro names used in the compiler directive described in the module B in FIG. 18, and the macro names used in the compiler directive described in the module C in FIG. 19 can be defined. Concretely, as described in a part of reference numeral 191 in FIG. 26, by using the compiler directive for conditional compilation, according to a macro name defined in the four macro names (SW_Low, SW_Normal, SW_High, and SW_High2), the macro names described in the modules A, B, and C can be selectively defined. That is, the four macro names (SW_Low, SW_Normal, SW_High, and SW_High2) correspond to selection pattern names in FIG. 21.

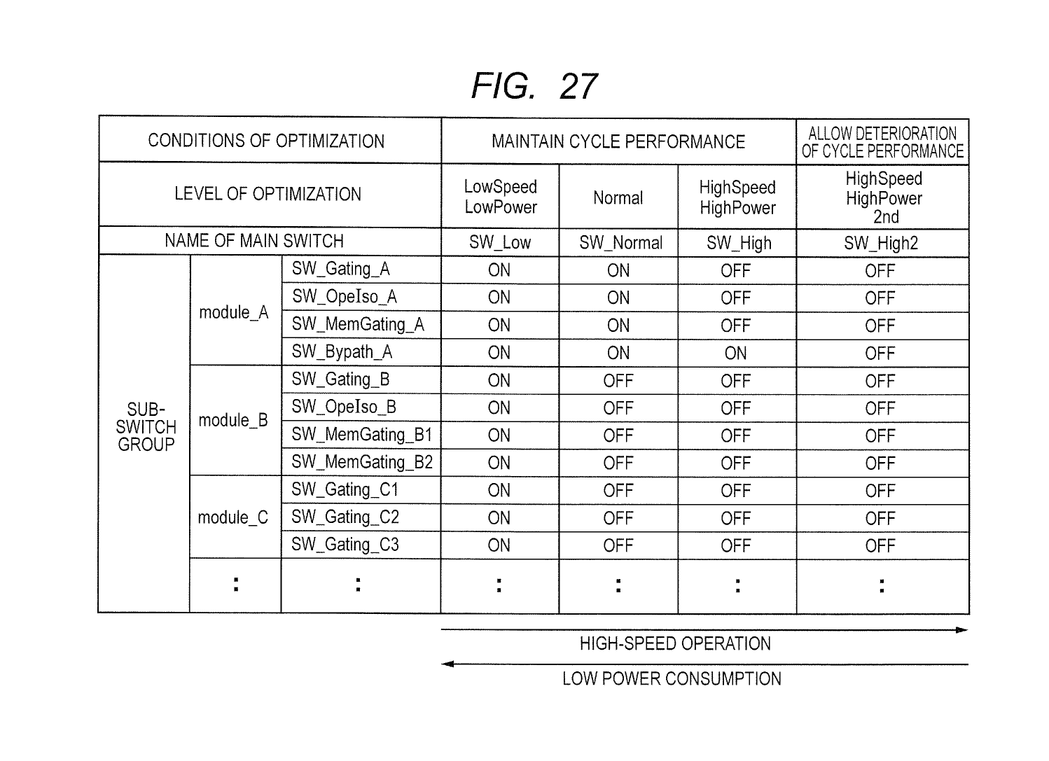

FIG. 27 is a diagram illustrating, in a table form, the relation between the name of a macro defined in FIG. 26 and power consumption and maximum operation frequency (high-speed operation) of the circuit. In FIG. 27, the case where a macro name is defined by the compiler directive “`define” is written as “ON” and the case where it is not defined is written as “OFF”. In FIG. 27, four macro names (SW_Low, SW_Normal, SW_High, and SW_High2) are called main switches, and macro names written in the modules A, B, and C are called sub-switches. The term of switch is abstract concept denoting selecting means and does not refer to a switch in an actual circuit.

Referring to FIGS. 26 and 27, in the case of defining the macro name SW_Low by using the compiler directive “`define”, all of macro names written in the modules A, B, and C (module_A, module_B, and module_C) are defined. As a result, although the power consumption of the semiconductor integrated circuit becomes the smallest (LowPower), the maximum operation frequency becomes also lower (LowSpeed).

In the case of defining the macro name SW_Normal by using the compiler directive “`define”, macro names written in the module A are defined but macro names written in the modules B and C are not defined. As a result, the power consumption and the maximum operation frequency of the semiconductor integrated circuit are adjusted to intermediate (“normal”). In the example of FIG. 26, the macro name SW_Normal is defined as it is written as “`define SW_Normal”.

In the case of defining the macro name SW_High by using the compiler directive “`define”, only the macro name SW_Bypath_A written in the module A is defined and other macro names are not defined. As a result, although power consumption increases (HighPower), higher-speed operation (HighSpeed) is obtained. Since the macro name SW_Bypath_A is defined, a bypass path is added to the pipeline circuit. Thus, high cycle performance is obtained.

In the case of defining the macro name SW_High2 by using the compiler directive “`define”, all of the macro names written in the modules A, B, and C are not defined. Consequently, power consumption further increases (HighPower), and higher-speed operation (HighSpeed) is also obtained. Since the macro name SW_Bypath_A is not defined, the cycle performance of the pipeline circuit decreases. For example, even when the bypass path in the pipeline circuit becomes a critical path on timing design, by not defining (off) the macro name SW_Bypath_A, the timings can be loosened and further higher-speed operation (increase in the operation frequency) can be realized.

As described above, by designing the four macro names (SW_Low, SW_Normal, SW_High, and SW_High2) as selecting means (main switch), one soft macro can be easily optimized on the basis of design specifications (power consumption and maximum operation power).

Although the circuit functions described with reference to FIGS. 4 to 15 can be selected in the above example, obviously, a circuit other than the above can be also selected. Although selection in four stages can be made as main switches in the above example, the options may be further increased.

Although the present invention achieved by the inventors herein has been concretely described on the basis of the embodiments, obviously, the invention is not limited to the foregoing embodiments but can be variously changed without departing from the gist.

What is claimed is:

1. A data structure of design data of a semiconductor integrated circuit,
wherein the design data includes circuit data at a register transfer level described in a hardware description language,
wherein the circuit data includes a first description expressing a specific module or a specific circuit element and a second description which is replaced with at least a part of the first description, thereby adding a new function to the specific module or the specific circuit element, and
wherein when a computer performs logic synthesis on the circuit data, either the logic synthesis is performed on the first description as it is, or at least a part of the first description is replaced with the second description and the logic synthesis is performed on the resultant is determined on the basis of predetermined selection information.

2. The data structure of design data of a semiconductor integrated circuit according to claim 1, wherein the design data includes the selection information.

3. The data structure of design data of a semiconductor integrated circuit according to claim 2,
wherein the circuit data includes a plurality of first descriptions expressing at least one of a plurality of specific modules and a plurality of specific circuit elements, and a plurality of second descriptions corresponding to the plurality of first descriptions,
wherein each of the second descriptions is replaced with at least apart of the first description, thereby adding a new function to a corresponding specific module or circuit element, and
wherein the circuit data includes information of a plurality of selection patterns expressing combinations of selection information for each of the specific modules or each of the circuit elements with respect to selection information for determining whether logic synthesis is performed on each of the first descriptions as it is or at least a part of each of the first descriptions is replaced with a corresponding second description and, then, the logic synthesis is performed on the resultant, and
wherein the computer performs the logic synthesis on the circuit data in accordance with a designated selection pattern of the plurality of selection patterns.

4. The data structure of design data of a semiconductor integrated circuit according to claim 3, wherein the plurality of selection patterns are preliminarily set so that power consumption and maximum operation frequency of a semiconductor integrated circuit produced on the basis of the circuit data change step by step in accordance with a selection result of the plurality of selection patterns.

5. The data structure of design data of a semiconductor integrated circuit according to claim 1,
wherein the specific circuit element includes a register to which a clock signal is input, and
wherein a new function added to the specific circuit element is a gating function of the clock signal.

6. The data structure of design data of a semiconductor integrated circuit according to claim 1,
wherein the specific module includes an arithmetic circuit to which operand data is input, and
wherein a new function added to the specific module is a function of isolating the operand data.

7. The data structure of design data of a semiconductor integrated circuit according to claim 1,
wherein the specific module includes a plurality of memory circuits to which an address signal and a data signal are input, and
wherein a new function added to the specific module is a function of gating an address signal and a data signal which are input to the memory circuits.

8. The data structure of design data of a semiconductor integrated circuit according to claim 1,
wherein the specific module includes an arithmetic circuit according to a pipeline method, and
wherein a new function added to the specific module is a data forwarding function.

9. The data structure of design data of a semiconductor integrated circuit according to claim 2,
wherein the hardware description language is Verilog-HDL,
wherein the second description and a description of a part corresponding to the first description are described so as to be able to be selected by a compiler directive designating a code to be complied according to whether a macro name is defined or not, and
wherein the selection information includes a description of defining the macro name.

10. An apparatus for designing a semiconductor integrated circuit, comprising:
a storing unit storing circuit data at a register transfer level described in a hardware description language; and
a data processing unit generating a net list by performing logic synthesis on the circuit data,
wherein the circuit data includes a first description expressing a specific module or a specific circuit element and a second description which is replaced with at least a part of the first description, thereby adding a new function to the specific module or the specific circuit element, and
wherein when the data processing unit performs logic synthesis on the circuit data, either the logic synthesis is performed on the first description as it is, or at least a part of the first description is replaced with the second description and the logic synthesis is performed on the resultant is determined on the basis of predetermined selection information.

11. A method of designing a semiconductor integrated circuit comprising the step of:
generating a net list by performing logic synthesis on circuit data at a register transfer level described in a hardware description language by a computer; and
generating a layout pattern by performing automatic placement and routing on the basis of the net list by the computer,
wherein the circuit data includes a first description expressing a specific module or a specific circuit element and a second description which is replaced with at least a part of the first description, thereby adding a new function to the specific module or the specific circuit element, and
wherein the step of generating the net list includes a step of determining either the logic synthesis is performed on the first description as it is, or at least a part of the first description is replaced with the second description and the logic synthesis is performed on the resultant on the basis of predetermined selection information.
